(19) United States
(12) Patent Application Publication
(10) Pub. No.: US 2003/0070094 A1
(43) Pub. Date: Apr. 10, 2003

(54) Data transfer across firewalls

(76) Inventors: John Isaac Chandan Gomes, Singapore (SG); Ngee Chuan Tan, Singapore (SG)

Correspondence Address: HEWLETT-PACKARD COMPANY, Intellectual Property Administration, P.O. Box 272400, Fort Collins, CO, 80527-2400, US

(21) Appl. No.: 10/135,949

(22) Filed: Apr. 30, 2002

(30) Foreign Application Priority Data
Oct. 6, 2001 (SG) 200106647-1

(51) Int. Cl. G06F 15/173; G06F 11/30

(52) U.S. Cl. 713/201; 340/5.1; 709/223

(57) ABSTRACT

A method for transferring data across a firewall is provided. According to the invention, a host computer which can access the data sends a poll periodically to a target computer for a presence of a data transfer instruction in the target computer. If the data transfer instruction is present in the target computer, in response to the poll, the target computer sends a response to the host computer to inform the host computer of at least part of the instruction. Based on the response from the target computer, the host computer transmits the data across the firewall to the target computer according to the part of the instruction.

### BACKGROUND OF THE INVENTION

This invention relates to electronic communications, and in particular to data transfer across firewalls.

With the advent of network, especially the Internet, users may want to share data with others through the network or to remotely access the data when the user is away from the data. For security reasons, however, firewalls are often erected to isolate and protect information systems within the firewalls from unauthorized access. Intranets are an example of such information system within the firewalls.

Erecting a firewall, however, also results in difficulties for the user outside the firewall to legitimately access the data stored in a computer within the firewall. A possible solution is that a network administrator designates a particular port with a definite protocol for the legitimate user outside the firewall to establish a connection with the computer where the data is stored and which is within the firewall. In this way, the user can legitimately penetrate the firewall and access the data accordingly.

Such a solution, however, requires help from the network administrator and also requires the user to use a definite protocol designated by the administrator.

Therefore, there is a need for a convenient way to provide a legitimate user outside a firewall with authorized access to the data stored in a computer system within the firewall.

### SUMMARY OF THE INVENTION

According to the present invention, in a process for transferring data across a firewall, a host computer which is within the firewall and has access to the data sends a poll periodically to a target computer outside the firewall for a presence of a data transfer instruction in the target computer. If the data transfer instruction is present in the target computer, in response to the poll, the target computer sends a response to the host computer to inform the host computer of at least part of the instruction. Based on the response from the target computer, the host computer transmits the data across the firewall to the target computer according to the part of the instruction.

In one aspect of the invention, the firewall includes a proxy computer. The proxy computer receives the poll from the host computer and then passes the poll to the target computer. The proxy computer also receives the response from the target computer and further passes the response to the host computer.

In another aspect of the invention, the polls received by the proxy computer and received by the target computer establish (1) a connection between the host computer and the proxy computer and (2) a connection between the proxy computer and the target computer respectively. Thus, a connection between the host computer and the target computer can be established across the firewall so as to allow the target computer to send the response across the firewall to the host computer.

Ideally, both the poll and the response are in a Hyper Text Transfer Protocol (HTTP) format.

Other aspects and advantages of the invention will become apparent from the following detailed description taken in conjunction with the accompanying drawings, which illustrate by way of example the principles of the invention.

### BRIEF DESCRIPTION OF THE DRAWINGS

FIG. 1 illustrates a network in which an embodiment according to the invention can be implemented;

FIG. 2 illustrates a flowchart of a process for transferring data across a firewall according to the invention; and

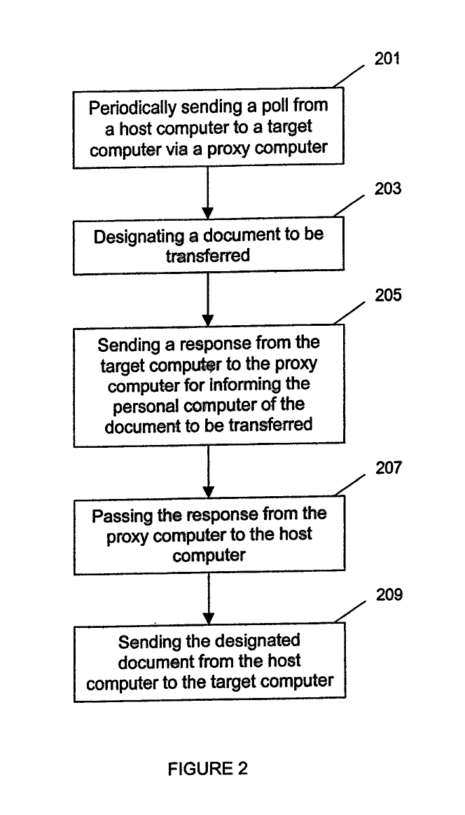

FIG. 3 illustrates an interface for a legitimate user to designate a document to be transferred.

### DETAILED DESCRIPTION OF THE INVENTION

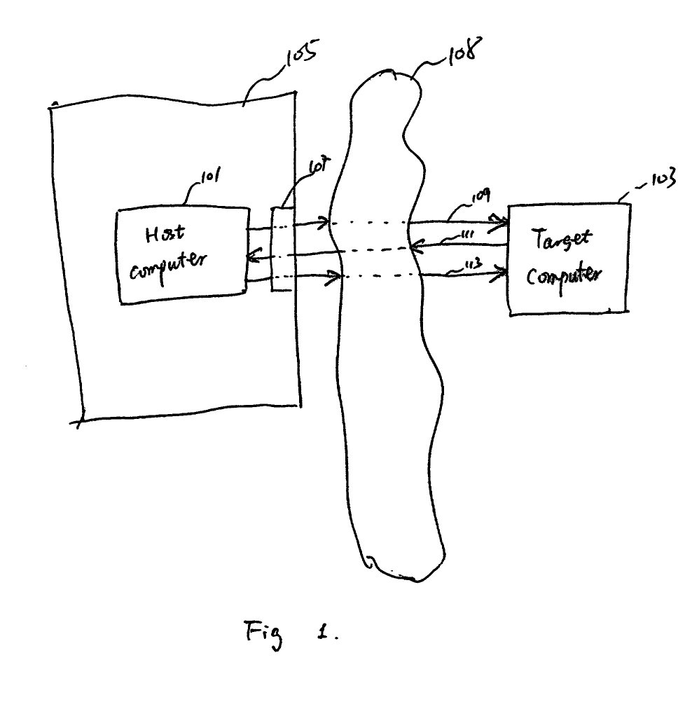

FIG. 1 illustrates a network in which an embodiment according to the invention can be implemented. A personal computer acting as a host computer 101, which stores documents to be transferred in the embodiment, is located within a firewall 105. The firewall 105, which protects the host computer 101 from unauthorized access, includes a proxy computer 107 through which the host computer 101 may communicate with a target computer 103 outside the firewall 105 via, for example, the Internet 108.

Generally, using a proxy computer applies an intermediary to break the connection between a sender and a receiver. All data flow is forwarded through the proxy computer. Hence a straight path is closed between an internal network within a firewall and a public network such as the Internet outside the firewall. In this way, the proxy computer prevents a cracker from obtaining internal addresses and details of the internal network. The proxy computer generally employs network address translation (NAT), which presents one organization-wide Internet Protocol (IP) address to the Internet. It funnels all user requests from the internal network to the Internet and fans responses back out to the appropriate users. The proxy computer may also cache Web pages, so that the next request can be obtained locally.

A proxy computer can be software installed in a regular computer or server. Such software products in the market today include WinGate from DeerField.com, a company based in Gaylord, Mich., and Microsoft Proxy Server from Microsoft Company based in Seattle, Wash. The host computer 101 needs to be configured to recognize the proxy computer 107. All future Internet accesses from the host computer 101 will be directed to the proxy computer 107 and then sent out to the Internet 108. With a Windows® 2000 operating system as an example, the configuration of the host computer 101 can be made through the “Internet option” provided in the “control panel.” Generally, the Internet option allows the user to specify a proxy computer for a computer.

In the embodiment, the documents in the host computer 101 have been shared out to the target computer 103 in advance; that is, filenames of these documents have been sent to and stored in the target computer 103 in advance. Particularly, when the user is operating the host computer 101, the user can select the files/documents in the host computer 101 to be shared, and a string of information is packed into an HTTP packet in the illustrative format shown below:

HTTP header

/MapleWML/CMServer/AddFile.asp

Username (for identifying the user)

User Password (for the purpose of security)

User-Entered Name (e.g., a friendly name for the file)

File Size

HTTP Trailer.

The parameter “User-Entered Name” identifies and is associated with the actual location of the individual file to be shared. By selecting such a user-entered name, the target computer 103 and the host computer 101 are able to identify the file to be transferred.

Such an HTTP packet then will be sent from the host computer 101 to the target computer 103. In this embodiment, upon receiving it, the target computer 103 is activated by the parameter “/MapleWML/CMServer/AddFile.asp” to run a script. Thus the information following this parameter, i.e., the Username, User password, User-Entered Name, and File size, will be added to a file database (not shown) of the target computer 103. The file database stores the filenames of the files shared out by each user.

When the user is away from the host computer 101, for example, when the user is at the target computer 103, the user may want to connect with the host computer 101 through the Internet 108 from the target computer 103 to remotely access the documents shared out. In particular, the user may want a softcopy of one of the documents which are stored in the host computer 101 and have been shared out.

However, the firewall 105 protects the host computer 101 against attacks, e.g., unauthorized inquiries from the Internet 108. Therefore, the target computer 103 is not able to initiate a communication with the host computer 101.

In the preferred embodiment, the target computer's IP address has been provided to the host computer 101 in advance. As shown by arrow 109 in FIG. 1, the host computer 101 initiates data transfer across the firewall by periodically sending a poll via the proxy computer 107 across the firewall 105 to the target computer 103 in Step 201.

A script is embedded in the host computer 101 to periodically send a poll. In this embodiment in which Windows® operating system is used, Windows® “SetTimer” API is used:

UINT SetTimer(UINT nIDEvent,UINT nElapse)

nIDEvent=a timer ID

nElapse=timer time. eg. 1000=1 sec

When the SetTimer is executed, the program would start timing based on the operating system timer, which runs constantly. When time is up, the “OnTimer,” a callback function defined by the Windows operating system, is automatically called by the operating system. Codes for executing the polling function can be embedded into the OnTimer function such that when time is up and when the OnTimer is executed, the host computer 101 sends a poll to the target computer 103.

Preferably, the poll is in an HTTP format. Specifically, a first HTTP request is sent from the host computer 101 to the proxy computer 107, which further passes the HTTP request to the target computer 103.

According to HTTP protocol, an HTTP request from a sender to a receiver will initiate the receiver to send an HTTP response back to the sender. Furthermore, in the preferred embodiment, HTTP requests and responses are sent using Transmission Control Protocol/Internet Protocol (TCP/IP). As known in the art, TCP/IP can be used to send/receive data on LANs (local area network), WANs (wide area network) and the Internet, and TCP/IP establishes a communication link between the sender and the receiver. Such a communication link enables responses from the receiver to be routed back to the sender. Besides, according to TCP/IP, if there is an error, the communication link will time out after a defined period.

The HTTP protocol, as specified by for example the “Internet Request for Comments RFC 1945” (T. Berners-Lee et al.), typically defines three types of requests, namely GET, POST, and HEAD. In the preferred embodiment, a POST request in an illustrative format shown below is sent to the proxy computer107:

HTTP header

/MapleWML/CMServer/Poll.asp

Username

User Password

HTTP Trailer.

In particular, the following Windows application program interfaces (API) are used in the host computer 101 to send the HTTP requests:

1. InternetOpen for initializing an application's use of the Windows Internet function and for specifying the IP address of the proxy computer used for the connection;

2. InternetConnect for specifying the target computer's location, for example, the IP address of the target computer 103 and for establishing an HTTP connection with computers outside the firewall through the proxy computer specified in InternetOpen;

3. HttpOpenRequest for creating a new HTTP request handle to store specified parameters;

4. HttpSendRequest for sending the specified request to the target computer.

With respect to HttpOpenRequest, an HTTP request handle holds a request to be sent to an HTTP server and contains all RFC822/MIME/HTTP headers to be sent as part of the request. In the case of an HTTP POST, the request contains the parameters “username” and the “password,” which are sent to the HTTP server, and is sent over HTTP protocol using the “POST” method. This is specified in the HTTP.

As discussed previously, the first HTTP request is directed to the proxy computer 107 first and then is sent to the target computer 103 outside the firewall 105. As the first HTTP request from the host computer is sent to the proxy computer 107 using TCP/IP, a first communication link is thus established between the proxy computer 107 and the host computer 101. Such a link enables an HTTP response in response to the first HTTP request to be routed back from the proxy computer 107 to the host computer 101.

Based on the first HTTP request from the host computer 101, the proxy computer 107 creates a second HTTP request on behalf of the host computer 101 in the following illustrative format:

HTTP header

/MapleWMUCMServer/Poll.asp

Username

User Password

HTTP Trailer.

Further, the proxy computer 107 locates the target computer 103 through its IP address, which is specified by the host computer 101 as a parameter in the InternetConnect API. The proxy computer 107 then sends the second HTTP request to the target computer 103 via the Internet 108 using TCP/IP. A second communication link is thus established between the proxy computer 107 and the target computer 103. The second communication link enables an HTTP response in response to the second HTTP request to be routed back from the target computer 103 to the proxy computer 107.

Through the first and the second communication links established, a connection between the host computer and the target computer can be established across the firewall so as to allow the target computer to send a response across the firewall to the host computer.

In response to the HTTP request received by the target computer 103, an HTTP response will be sent from the target computer 103 to the host computer 101 via the proxy computer 107. Further, if a data transfer instruction is present in the target computer 103, a positive HTTP response will be sent from the target computer 103 to the host computer 101 to inform it of the presence of the data transfer instruction. If no data transfer instruction is present in the target computer 103, however, an HTTP response will also be sent to inform the host computer 101 of the absence of the data transfer instruction accordingly.

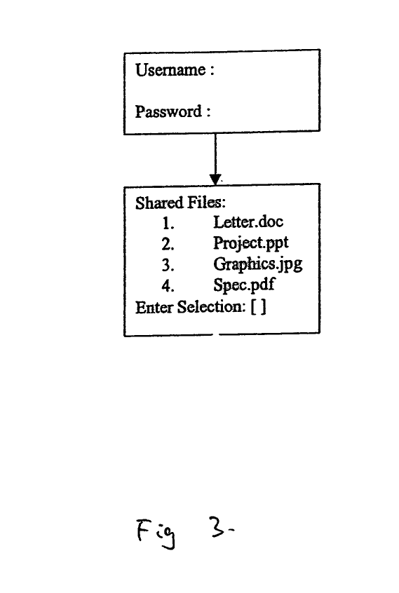

The data transfer instruction can be entered manually. For example, the user sitting at the target computer 103 may prompt an interface illustrated by FIG. 3 in which a list of filenames of the documents shared out by the user is shown. In Step 203, the user designates a document to be transferred from the host computer 101 to the target computer 103 by for example selecting a filename from the list shown in FIG. 3. Such a selection will be sent to the host computer 101 via the proxy computer107.

In addition, in response to the data transfer instruction, the target computer 103 creates a parameter JobID for identifying the data transfer in the ensuing process.

The target computer 103 incorporates the JobID and the filename selected by the user into a second HTTP response in the following illustrative format:

HTTP header

JobID

Filename

HTTP Trailer.

If no data transfer instruction is present at the central server 103, however, the target computer 103 can create such a second HTTP response to inform the host computer 101 of the absence of the data transfer instruction in the following format:

HTTP header

<T>

HTTP Trailer.

Through the second communication link between the proxy computer 107 and the target computer 103 established by the second HTTP request, the second HTTP response in response to the second HTTP request is sent from the target computer 103 to the proxy computer 107 using TCP/IP in Step 205. In Step 207, similarly to what it has done to the first HTTP request, the proxy computer 107 incorporates the second HTTP response into a first HTTP response and further sends the first HTTP response to the host computer 101 within the firewall 105 through the first communication link established.

Upon receiving the HTTP response, the host computer 101 extracts returned parameters, i.e., “JobID” and “Filename” in the case of a data transfer instruction being present in the target computer 103, from the first HTTP response using the following APIs:

1. InternetQueryDataAvailable for querying the amount of data available after an HTTPSendRequest; and

2. InternetReadFile for reading data from the HTTP response.

Subsequently, the host computer 101 retrieves the parameters “JobID” and “Filename,” and accordingly extracts the file identified by the parameter “Filename”. Thereafter, the host computer 101 packs the file into a third HTTP request, for example:

HTTP Header

/MapleWML/CMServer/FileUpload.asp

Username

User Password

A First Filename

Size of the file

JobID

File Content

HTTP Trailer,

wherein the parameter “JobID” identifies the job, especially, where the document to be transferred comes from.

Such a third HTTP request is then sent from the host computer 101 via the proxy computer 107 across the firewall 105 to the target computer 103 using TCP/IP in Step 209. The parameter “/MapleWML/CMServer/FileUpload.asp” will initiate the target computer 103 to retrieve the information contained therein, including the designated document which is contained in “File Content,” and to store it in a database (not shown) of the target computer.

Upon receiving the third HTTP request, the target computer 103 composes a third HTTP response to inform the host computer 101 of the receipt of the document, and similarly the third HTTP response will be routed back to the host computer 101 via the proxy computer 107.

Alternatives can be made to the embodiment described above. For example, HTTP requests and responses can be sent using other protocols such as User Datagram Protocol/Internet Protocol (UDP/IP), and Internet Packet Exchange (IPX).

Besides, the documents can be stored in other computers preferably also withinthe firewall 105 and accessible by the host computer 101. In that case, upon receiving the HTTP response that informs the host computer 101 of the file to be retrieved in parameter “Filename,” the host computer 101 will access the computer where the file is saved and retrieve the file therefrom accordingly.

In addition, if the data transfer instruction is not present at the target computer 103, a response from the target computer may not be necessary. The host computer 101 will recognize the absence of the data transfer instruction if it does not receive an appropriate response from the target computer within a predefined period.

What is claimed is:

1. A process for transferring data from a host computer across a firewall to a target computer, the process comprising:
periodically sending a poll from the host computer across the firewall to the target computer for a presence of a data transfer instruction in the target computer;
in response to the poll, sending a response from the target computer to the host computer to inform the host computer of at least part of the instruction if the data transfer instruction is present in the target computer; and
transmitting the data from the host computer across the firewall to the target computer according to the part of the instruction.

2. The process of claim 1, wherein the firewall includes a proxy computer, and wherein the step of polling includes:
sending the poll from the host computer to the proxy computer so as to establish a first communication link between the host computer and the proxy computer; and
passing the poll to the target computer by the proxy computer so as to establish a second communication link between the proxy computer and the target computer.

3. The process of claim 2, wherein the step of responding includes:
sending information relating to the instruction from the target computer to the proxy computer; and
passing the information from the proxy computer to the host computer.

4. The process of claim 3, wherein the first communication link allows the information to be routed back from the proxy computer to the host computer, and wherein the second communication link allows the information to be routed back from the target computer to the proxy computer.

5. The process of claim 2, wherein the poll is sent using Transmission Control Protocol/Internet Protocol.

6. The process of claim 1, wherein the poll is in a Hyper Text Transfer Protocol format.
